(19) United States
(12) Patent Application Publication
(10) Pub. No.: US 2010/0050981 A1
(43) Pub. Date: Mar. 4, 2010

(54) Rotary internal combustion engine

(76) Inventors: Richard T. Ivas, St. Petersburg, FL (US); Gary A. Kelley, St. Petersburg, FL (US)

Correspondence Address: ANDREW F. KNIGHT, 47659 Comer Square, Sterling, VA, 20165, US

(21) Appl. No.: 12/584,095

(22) Filed: Aug. 31, 2009

Related U.S. Application Data
(60) Provisional application No. 61/191,010, filed on Sep. 4, 2008.
(60) Provisional application No. 61/207,445, filed on Feb. 12, 2009.

(51) Int. Cl. F02B 53/04

(52) U.S. Cl. 123/228

(57) ABSTRACT

A non-reciprocating circular engine includes a casing, a power-compression piston and an intake-exhaust piston connected to a central hub and movable along a circular path, a power-exhaust gate and a compression-intake gate each rotatable about an axis and configured to automatically open and close according to a position of at least one of the pistons, and a compression chamber located between the gates and comprising a recession formed into the casing. The engine is configured so that, in every cycle, only the power-compression piston provides a power stroke and compresses a gas for combustion, and only the intake-exhaust piston provides for intake of gas and exhaust of combustion gases.

### RELATED APPLICATIONS

This application claims priority to U.S. Provisional Patent Applications Nos. 61/191,010, filed Sep. 4, 2008, and 61/207,445, filed Feb. 12, 2009, both entitled “A non-reciprocating internal combustion engine,” the disclosures of which are hereby incorporated by reference.

### BACKGROUND

Modern reciprocating internal combustion engines suffer from the complexities of reciprocation, including high stresses on piston rods. Non-reciprocating engines have advantages over reciprocating engines, but have their own disadvantages.

### SUMMARY OF THE INVENTION

The term “rotary engine,” as used herein, refers broadly to any non-reciprocating engine, including engines in which pistons travel circular paths. Modern rotary engines suffer from various disadvantages, including inefficiencies. The present invention aims to solve one or more of these and other problems.

According to an embodiment of the present invention, a non-reciprocating circular engine comprises: a casing comprising a circular path; a central hub rotatably connected to the casing and configured to rotate in a preferred direction; at least one piston connected to the central hub and movable along the circular path, the piston having a piston arc length and a front surface and a back surface relative to motion along the circular path; at least one exhaust gate rotatable about an axis and having an open position and a closed position, wherein the at least one exhaust gate is configured to automatically open and close according to a position of the at least one piston, and wherein the at least one exhaust gate rotates from the closed position to the open position in a direction opposite the preferred direction; at least one intake gate rotatable about an axis and having an open position and a closed position, wherein the at least one intake gate is configured to automatically open and close according to a position of the at least one piston, and wherein the at least one intake gate rotates from the closed position to the open position in a direction opposite the preferred direction; and at least one compression chamber located circumferentially between the at least one exhaust gate and the at least one intake gate along a shortest path, the compression chamber comprising a recession formed into the casing, wherein the central hub is caused to rotate at least in part by force exerted by high pressure combustion gases between the back surface of the at least one piston and the at least one exhaust gate in its closed position, and wherein the at least one piston comprises a channel extending from a first end to a second end, the first end located in at least one of the front surface and the back surface, the second end located in a periphery corresponding to a location of the at least one compression chamber.

In one aspect, the first end of the channel is located at the front surface. In one aspect, the first end of the channel is located at the back surface. In one aspect, the channel extends a channel arc length of between approximately 20% and 50% of the piston arc length. In one aspect, the engine comprises at least two pistons, at least two exhaust gates, at least two intake gates, and at least one compression chamber.

In one aspect, the at least one exhaust gate comprises an exhaust conduit within the at least one exhaust gate configured for the passage of exhaust gases, the at least one exhaust gate is configured to align the exhaust conduit with an exhaust port in the casing when the at least one exhaust gate is in the closed position, the at least one intake gate comprises an intake conduit within the at least one intake gate configured for the passage of intake gases, and the at least one intake gate is configured to align the intake conduit with an intake port in the casing when the at least one intake gate is in the closed position.

In one aspect, the at least one compression chamber comprises a concave recession formed into the casing, the concave recession being rounded and having a compression chamber arc length not greater than the piston arc length. In one aspect, the compression chamber arc length is greater than a compression chamber height. In one aspect, the back surface of the at least one piston has a back surface shape that substantially matches an exhaust shape of the at least one exhaust gate on a forward side.

In one aspect, the at least one piston comprises a pressure-containing arc length through which gas passage within the circular path is substantially restricted, and wherein a compression chamber arc length exceeds the pressure-containing arc length so that for a portion of a cycle gas may pass unobstructed from a front of the at least one piston to a back of the at least one piston.

According to an embodiment of the present invention, a non-reciprocating circular engine comprises: a casing comprising a circular path having an inner circumference and an outer circumference; a central hub rotatably connected to the casing and configured to rotate in a preferred direction; at least one piston connected to the central hub and movable along the circular path, the piston having a piston arc length and a front surface and a back surface relative to motion along the circular path; at least one exhaust gate rotatable about an axis, having an open position and a closed position, and comprising an exhaust conduit within the at least one exhaust gate configured for the passage of exhaust gases, wherein the at least one exhaust gate is configured to automatically open and close according to a position of the at least one piston, wherein the at least one exhaust gate rotates from the closed position to the open position in a direction opposite the preferred direction, and wherein the at least one exhaust gate is configured to align the exhaust conduit with an exhaust port in the casing when the at least one exhaust gate is in the closed position; at least one intake gate rotatable about an axis, having an open position and a closed position, and comprising an intake conduit within the at least one intake gate configured for the passage of intake gases, wherein the at least one intake gate is configured to automatically open and close according to a position of the at least one piston, wherein the at least one intake gate rotates from the closed position to the open position in a direction opposite the preferred direction, and wherein the at least one intake gate is configured to align the intake conduit with an intake port in the casing when the at least one intake gate is in the closed position; and at least one compression chamber located circumferentially between the at least one exhaust gate and the at least one intake gate along a shortest path, the compression chamber comprising a recession formed into the casing, wherein the central hub is caused to rotate at least in part by force exerted by high pressure combustion gases between the back surface of the at least one piston and the at least one exhaust gate in its closed position.

According to an embodiment of the present invention, a non-reciprocating circular engine comprises: a casing comprising a circular path; a central hub rotatably connected to the casing and configured to rotate in a preferred direction; a power-compression piston connected to the central hub and movable along the circular path, the power-compression piston having a front surface and a back surface relative to motion along the circular path; an intake-exhaust piston connected to the central hub and movable along the circular path, the intake-exhaust piston having a front surface and a back surface relative to motion along the circular path; a power-exhaust gate rotatable about an axis and having an open position and a closed position, wherein the power-exhaust gate is configured to automatically open and close according to a position of at least one of the power-compression piston and the intake-exhaust piston, and wherein the power-exhaust gate rotates from the closed position to the open position in a direction opposite the preferred direction; a compression-intake gate rotatable about an axis and having an open position and a closed position, wherein the compression-intake gate is configured to automatically open and close according to a position of at least one of the power-compression piston and the intake-exhaust piston, and wherein the compression-intake gate rotates from the closed position to the open position in a direction opposite the preferred direction; and a compression chamber located circumferentially between the power-exhaust gate and the compression-intake gate along a shortest path, the compression chamber comprising a recession formed into the casing, wherein the central hub is caused to rotate at least in part by force exerted by high pressure combustion gases between the back surface of the power-compression piston and a front surface of the power-exhaust gate in its closed position, and wherein the engine is configured so that, in every cycle, only the power-compression piston provides a power stroke and compresses a gas for combustion, and only the intake-exhaust piston provides for intake of gas and exhaust of combustion gases.

### BRIEF DESCRIPTION OF THE DRAWINGS

FIG. 1 shows a side view of a non-reciprocating circular engine according to one embodiment of the present invention, with one side of the casing removed to expose the inside of the engine.

FIG. 2 shows a side view of a non-reciprocating circular engine according to one embodiment of the present invention, with one side of the casing removed to expose the inside of the engine.

FIG. 3 shows a side view of a non-reciprocating circular engine according to one embodiment of the present invention, with one side of the casing removed to expose the inside of the engine.

FIG. 4 shows a side view of a non-reciprocating circular engine according to one embodiment of the present invention, with one side of the casing removed to expose the inside of the engine.

FIG. 5 shows a side view of a non-reciprocating circular engine according to one embodiment of the present invention, with one side of the casing removed to expose the inside of the engine.

FIG. 6 shows a side view of a non-reciprocating circular engine according to one embodiment of the present invention, with one side of the casing removed to expose the inside of the engine.

FIG. 7 shows a side view of a non-reciprocating circular engine according to one embodiment of the present invention, with one side of the casing removed to expose the inside of the engine.

FIG. 8 shows a side view of a non-reciprocating circular engine according to one embodiment of the present invention, with one side of the casing removed to expose the inside of the engine.

FIG. 9 shows a side view of a non-reciprocating circular engine according to one embodiment of the present invention, with one side of the casing removed to expose the inside of the engine.

FIG. 10 shows a side view of a non-reciprocating circular engine according to one embodiment of the present invention, with one side of the casing removed to expose the inside of the engine.

FIG. 11 shows a front view of a power-compression piston according to an embodiment of the present invention.

FIG. 11a shows a design view of the power-compression piston shown in FIG. 11.

FIG. 12 shows a side view of the power-compression piston shown in FIG. 11.

FIG. 12a shows a design view of the power-compression piston shown in FIG. 12.

FIG. 13 shows a close-up side view of a compression chamber and gates of the embodiment shown in FIG. 9.

### DETAILED DESCRIPTION

In the following description, the use of “a”; “an”, or “the” can refer to the plural. All examples given are for clarification only, and are not intended to limit the scope of the invention.

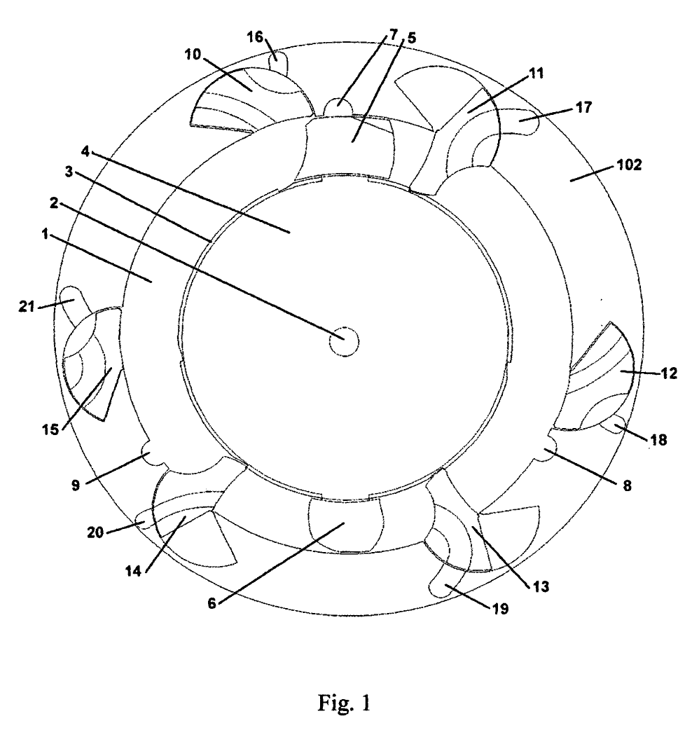

Referring now to FIG. 1, a non-reciprocating circular engine comprises a casing 102 having one or more circular cylinders or circular paths 1 mounted around a central hub 2, which is rotatably connected to the casing 102 and configured to rotate in a preferred direction (which may be clockwise or counterclockwise relative to FIG. 1). A disc 4 is attached to the central hub 2 and passes through the casing 102 and into circular path 1 via slot 3. The disc 4 extends adjacent to or into the circular cylinder or circular path 1 and forms a seal to accommodate both piston travel and the containment of the gases required for, and ultimately produced by, combustion. Attached to each disc 4 is at least one and preferably a set of double-faced pistons 5, 6, such that pistons 5, 6 are connected to the central hub 2 via the disc 4 and are movable along the circular path 1. In one embodiment, there are an even number of pistons 5, 6, so that half of them are intake-exhaust pistons 5 and half of them are power-compression pistons 6. In the embodiment shown in FIG. 1, there is exactly one power-compression piston 6 and exactly one intake-exhaust piston 5.

Unique functions of the pistons include: intake of any gas related to combustion or deflagration (such as, but not limited to, air, gaseous fuel such as propane or vaporized gasoline, gaseous oxidizer such as nitrous oxide, an fuel-air mixture, and so forth) is performed by the retreating surface (or back surface relative to motion along the circular path 1) of the intake-exhaust piston(s) 5, while the expulsion of the spent gases after combustion is performed by the forward surface (or front surface relative to motion along the circular path 1) of the same piston(s) 5; compression of the previously in-taken gas (e.g., air, fuel-air mixture, etc.) is performed by the forward surface (or front surface relative to motion along the circular path 1) of the power-compression piston(s) 6, while the retreating surface (or back surface relative to motion along the circular path 1) of the same piston(s) 6 is propelled by the expanding gases of combustion in the power stroke.

One or more compression chambers or compression chambers 7, 8, 9 are positioned along the circumference of and contiguous with each circular cylinder or circular path 1. Chambers 7, 8, 9 may comprise a recession formed into the casing 102. Each compression chamber 7, 8, 9 is co-located with and located between a paired set of gates such that each compression chamber 7, 8, 9 is controlled by pairs of control gates (pair 10 and 11, pair 12 and 13, and pair 14 and 15. For example, compression chamber 7 is located circumferentially between a power-exhaust gate 10 and a compression-intake gate 11 along a shortest path between these two gates 10, 11. Similarly, compression chamber 8 is located circumferentially between a power-exhaust gate 12 and a compression-intake gate 13 along a shortest path between these two gates 12, 13, and compression chamber 9 is located circumferentially between a power-exhaust gate 14 and a compression-intake gate 15 along a shortest path between these two gates 14, 15.

For example, positioned adjacent to the entrance of the compression chamber 7 is the power-exhaust gate 10, and adjacent the exit of the compression chamber 7 is the compression-intake gate 11. Each gate 10, 11, 12, 13, 14, 15, in addition to controlling power and compression functions for their respective compression chambers 7, 8, 9, may also control an intake or an exhaust port adjacent to their respective compression chambers 7, 8, 9 or to preceding or subsequent compression chambers 7, 8, 9 located along the circular path 1.

Because compression cannot begin until the compression-intake gate 11, 13, 15 has closed, the opening and closing of the gates, most specifically the compression-intake gate 11, 13, 15, can be adjusted to allow for attenuated compression ratios. In this concept, the greater the duration of gate opening prior to arrival of a power-compression piston 6, the less area is available for the purpose of compression by that advancing power-compression piston 6. Such control of the timing of gates provides a simple and efficient means of performing the functions of and operating a true variable-compression ratio engine.

### Legend for FIG. 1

1. Circular cylinder or circular path
2. Central hub
3. Slot
4. Disc
5. Intake-exhaust piston
6. Power-compression piston
7. Compression chamber
8. Compression chamber
9. Compression chamber
10. Power-exhaust gate
11. Compression-intake gate
12. Power-exhaust gate
13. Compression-intake gate
14. Power-exhaust gate
15. Compression-intake gate
16. Exhaust port
17. Intake port
18. Exhaust port
19. Intake port
20. Exhaust port
21. Intake port
102. Casing

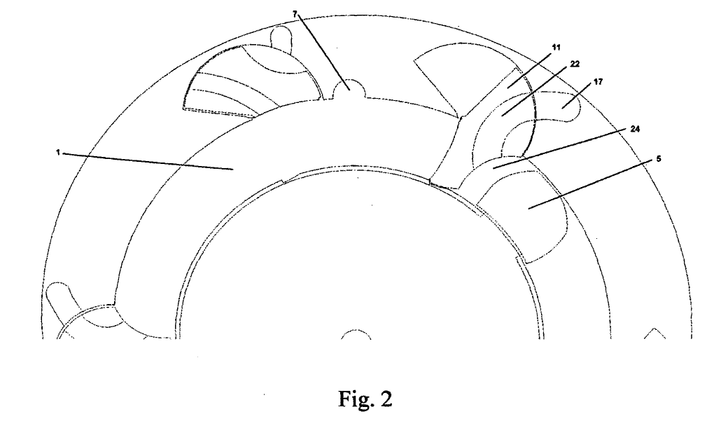

A method of operating the non-reciprocating circular engine shown in FIG. 1 is described with reference to FIGS. 2-10. In FIG. 2, intake-exhaust piston 5 is advanced in the circular path 1 to a point where intake-exhaust piston 5 passes beyond compression chamber 7 through an open compression-intake gate 11. As the piston 5 continues its travel, gate 11 closes behind intake-exhaust piston 5. Air (or an air/fuel mixture or any other gas related to combustion or deflagration) 24 is drawn, injected or otherwise enters into the circular path 1 via open intake port 17 aligned with an existing conduit 22 embodied in the compression-intake gate 11 and configured for the passage of intake gases.

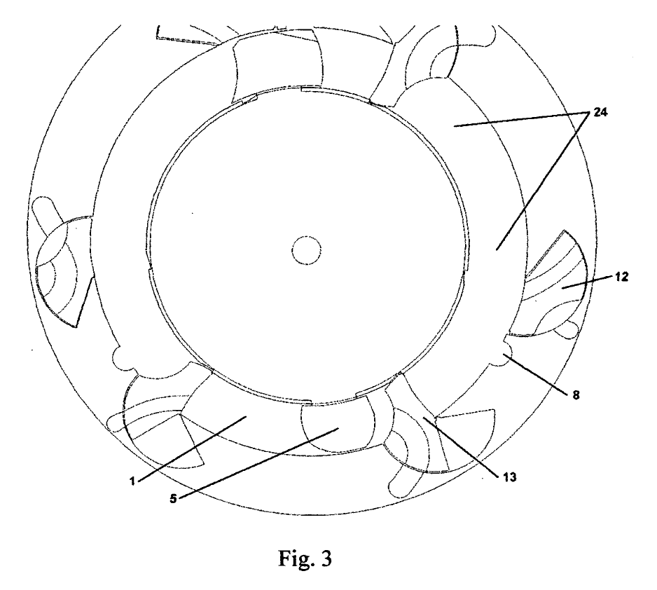

In FIG. 3, the intake-exhaust piston 5 continues its travel along the circular path 1 through open power-exhaust gate 12, past the next compression chamber 8 exiting through the open compression-intake gate 13, which subsequently closes after piston passage. The compression chamber 8 is now fully charged with air (or air/fuel mixture) 24.

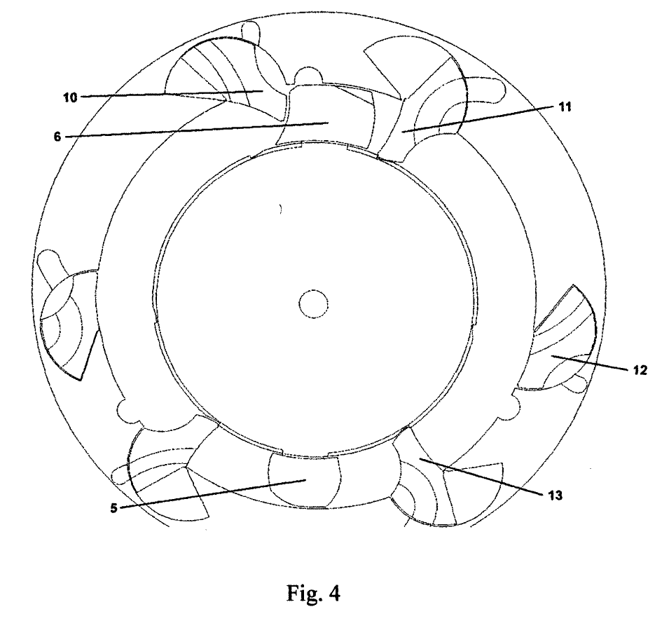

FIG. 4 shows power-exhaust gate 12 (through which intake-exhaust piston 5 has passed) remaining open and that compression-intake gate 13 has closed following the passage of intake-exhaust piston 5. Power-compression piston 6 is passing the preceding power-exhaust gate 10 (which will close) and approaching the soon-to-open compression-intake gate 11.

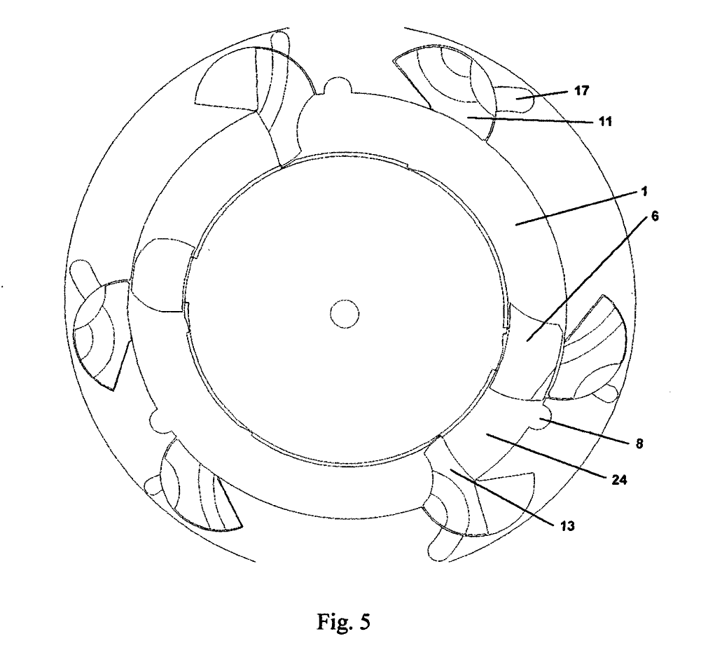

In FIG. 5, a following power-compression piston 6 is allowed to enter the area of the circular path 1 preceding the compression chamber 8 through compression-intake gate 11 and continues to compress the air (or air/fuel mixture) 24 against the now-closed compression-intake gate 13 toward which it is traveling. The opening of compression-intake gate 11 to allow passage of power-compression piston 6 also closes off the intake port 17.

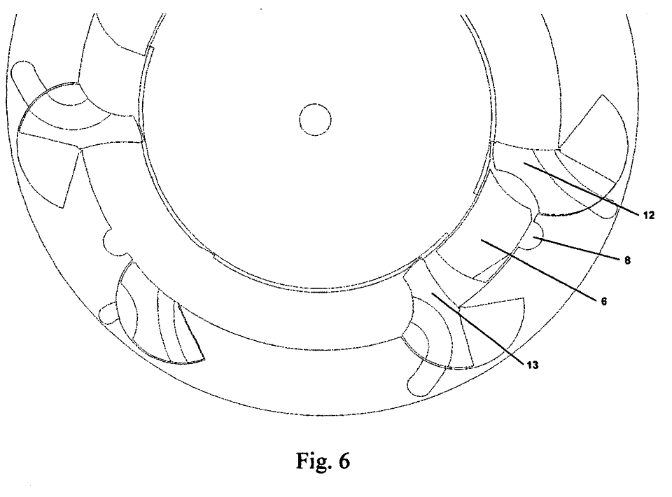

In FIG. 6, power-compression piston 6 continues its travel to a point short of contact with the closed compression-intake gate 13 and adjacent to the compression chamber 8. This position is designated as the point of “Top Dead Center” and compression is now complete. Power-exhaust gate 12 closes, then compression-intake gate 13 opens. Opening and closing of all gates at the appropriate times can be facilitated by means of a timing gear, a cam, hydraulics, pneumatics, electro-mechanical devices, a processor or computer, or a combination thereof or other means, as appropriate.

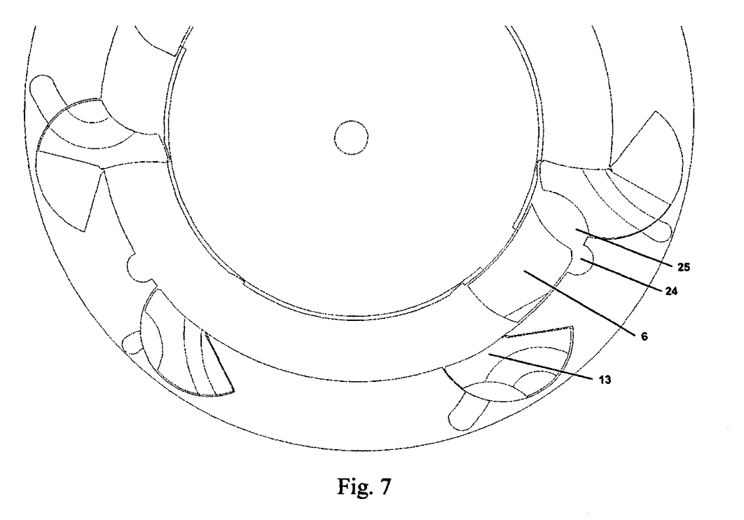

In FIG. 7, continued slight advancement past this point of Top Dead Center then exposes the rear edge (or back surface, relative to the clockwise direction of rotation of the central hub 2 shown in FIGS. 2-10) of the power-compression piston 6 to the compression chamber 8 allowing the now-compressed air (or air/fuel mixture) 24 to begin to flow to the piston's rear face or back surface. If fuel was not previously introduced, fuel could be added or injected at approximately this time to make a fuel-air mixture. Ignition is initiated at this point either by compression ignition, spark or any other means known in the art. The resulting high-pressure combustion gases 25 between the back surface of the power-compression piston 6 and a front surface of the power-exhaust gate 12 (in its closed position) then drives the power-compression piston 6 further along the circular path 1 through the just-recently-opened compression-intake gate 13.

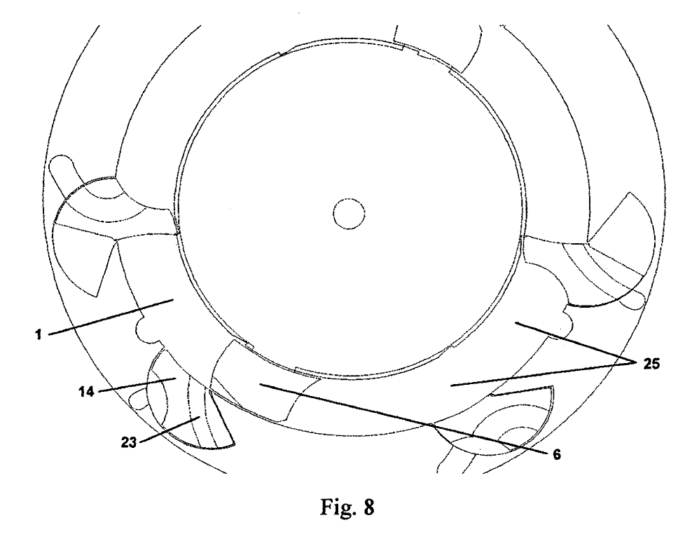

In FIG. 8, the power-compression piston 6, propelled by the expanding combustion gases 25 travels further along the circular path 1 until passage of the piston 6 beyond a closing power-exhaust gate 14. Upon subsequent closure of the power-exhaust gate 14, an exhaust conduit 23 embodied within the gate 14 aligns with an exhaust port 20 (shown in FIG. 1), providing an escape point for the spent or combusted gases.

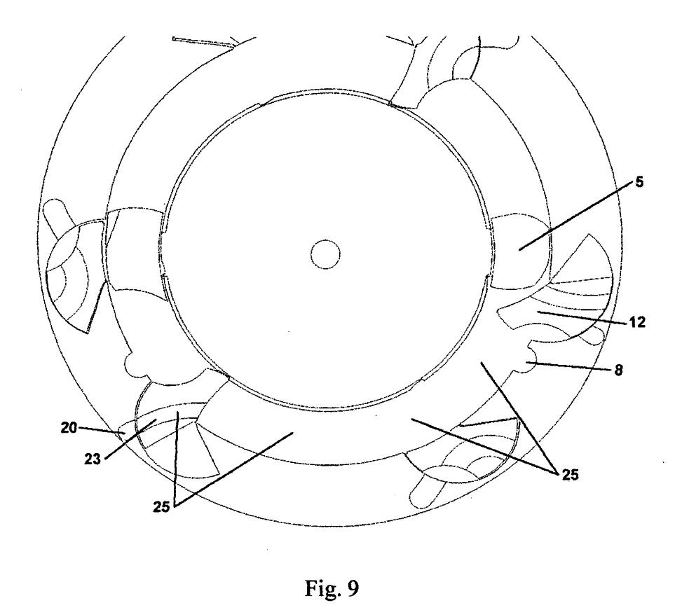

Next, in FIG. 9, the power-exhaust gate 12 opens to allow a following intake-exhaust piston 5 (not necessarily the same one as first discussed, in the case of multiple pairs of pistons) to enter the portion of the circular path 1 adjacent to the compression chamber 8, continuing forward so that the front surface acts to expel remaining exhaust gases 25 through exhaust conduit 23 and the exhaust port 20.

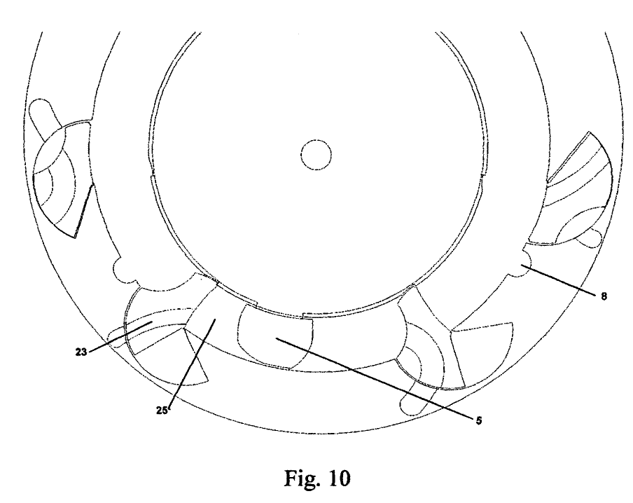

Finally, in FIG. 10, the intake-exhaust piston 5 has cleared the combustion gases 25 from compression chamber 8 out of the circular path 1 through the exhaust conduit 23. The entire intake, compression, power, and exhaust cycle relative to chamber 8 is now completed, and the cycle is set to begin anew.

This method, described above and with subsequent iterations, will be henceforth referred to as the “GARRIC CYCLE.” While the traditional Otto cycle may produce power utilizing four elements or functions (intake, compression, ignition, and exhaust) via a single piston through two revolutions, the Garric cycle incorporates at least one or multiple paired double-headed pistons traveling at most a single revolution to complete the cycle. In the Otto cycle, while it is necessary for each of the four elements/functions of power to be conducted sequentially to one another, the Garric cycle allows for a piston to perform multiple functions simultaneously (i.e., a piston performing intake is simultaneously exhausting previously burned gases, and a piston compressing gases in front of it is simultaneously performing the power cycle behind it).

According to one embodiment of the present invention, a method involves actuation of the gates by a system (which may be either selectively adjustable or operated autonomously) which detects required performance output, necessary load, throttle position or other parameter(s), thus allowing for a delay in the closing of the compression-intake gate such that the time and area available for compression of the air or fuel-air mixture is reduced. Subsequently, the amount of fuel required for combustion could be also reduced, allowing for gains in fuel economy and a reduction in emissions. It is contemplated that a delayed closing of the compression-intake gate, when coupled with a normal opening of the power-exhaust gate, could produce the efficiencies of an Atkinson cycle engine. According to one embodiment of the present invention, a method for variably timed opening and closing of gates may be accomplished by the use of electronically controlled actuators. Further, computer control of the gate timing may be utilized.

This engine may be well suited for any engine application which utilizes high torque output, such as but not limited to: power generation, diesel-electric (though not limited to diesel as a fuel) locomotion, marine applications, etc., and may potentially be used for most any application which has conventionally used an internal combustion or turbine engine.

The shape of the cylinder may be square, rectangular, elliptical, trapezoidal or any other shape, as long as the piston contained therein travels in an orbit and/or circular path around the central hub 2. According to one embodiment of the present invention, the orbit (or circular movement) around the central hub may be circular in shape, although this does not preclude the use of an elliptical or epicyclic path.

According to one embodiment of the present invention, the slot 3 in the above drawings may be introduced into each cylinder through which a disc 4 extends from the central hub 2 into the interior of each cylinder or circular path 1. The joint between the rotating disc 4 and the circular path 1 would, therefore, form a seal to accommodate both piston travel and the containment of the gases required for and ultimately produced by combustion. The slot 3, while shown herein to be located along the interior of the circular path 1, could be located at any point on the circular path 1 (bottom, side or even top) to gain efficiencies not available through the location depicted here.

Depending on the dimensions of the circular path 1, more or fewer compression chambers could be added along the circular path 1 and share the same paired piston set(s), thus providing additional power pulses per revolution or more cycles per revolution. Additional piston pairs could be also be added thereby providing for multiple power pulses per compression chamber per revolution.

The compression chambers 7, 8, 9 may be located other than along the outer edge, such as along the side of the circular path 1 rather than on the outer edge or circumference. It is also contemplated that there may be multiple circular paths 1, possibly arrayed in multiples (most often pairs), connected through the central hub 2. Paired array circular paths 1 could also be connected at the central hub 2 via a gear system or other method so that the pistons within each circular path 1 turn contra, or in a direction opposed to one another. This configuration would negate any induced gyroscopic or torque forces thereby producing a very smooth running engine.

Smoothness could be further enhanced by locating the compression chambers 7, 8, 9 within each circular path 1 at intervals to the compression chambers within the other circular path(s). Such a configuration would provide power impulses at reduced intervals more closely timed to one another. As an example: if compression chambers in circular cylinder #1 were located at 0 degrees, 90 degrees, 180 degrees, and 270 degrees from the vertical plane, compression chamber location in circular cylinder #2 could be located at an intermediate angle such as 45 degrees, 135 degrees, 225 degrees, and 315 degrees, and discs corresponding to each circular path 1 may rotate in opposite directions. Any other degree intervals could be employed. Multiple arrays of single or paired circular paths 1 could also be assembled if additional power was desired.

Utilizing paired (or multiple) circular paths 1 may allow for one or more of the engines to rest and not fire when power requirements are reduced. A preferred method of resting or turning off one (or more) of the multiple engines, leaving at least one engine operating, would be to actuate all of the gates to an open position in the non-working or resting circular path(s).

Gate architecture may also be modified from the nautilus type shape as shown. Gates may be cylindrical, ball- or disc-shaped as well, and pivot either from their respective center points or the pivot point could be offset from center. Further, rotation points may be located approximately at, or outside of, the outer circumference of the circular path 1. Gates of any shape could also be incorporated, operating in a piston-like fashion entering and retracting from the circular path 1 at the appropriate times or swinging as a door hinged at any point on the gate. This latter method may prove to be best suited to paired cylinders/engines with contra rotating discs wherein the gate would enter one circular path as it exits the other. Also, due to the reduced vibration afforded by the absence of reciprocating pistons, ceramic or other materials may potentially be utilized to reduce lubrication and cooling requirements, as well to approach the efficiencies inherent in an adiabatic-type engine.

Referring now to FIGS. 11 and 11a, the piston architecture may have an area built into the power-compression piston(s) (connected to disc 4) such as a slot or channel 51 that is machined, cast or otherwise incorporated into the front face 52 and along the linear side facing the compression chamber(s) for a portion of length along the piston body to provide a path for compressed air or air/fuel mixture to continue to flow into the compression chamber. Alternatively or in addition, a port could be drilled into the piston face 52 and exiting the piston body at the appropriate point along its linear side, as with the aforementioned slot.

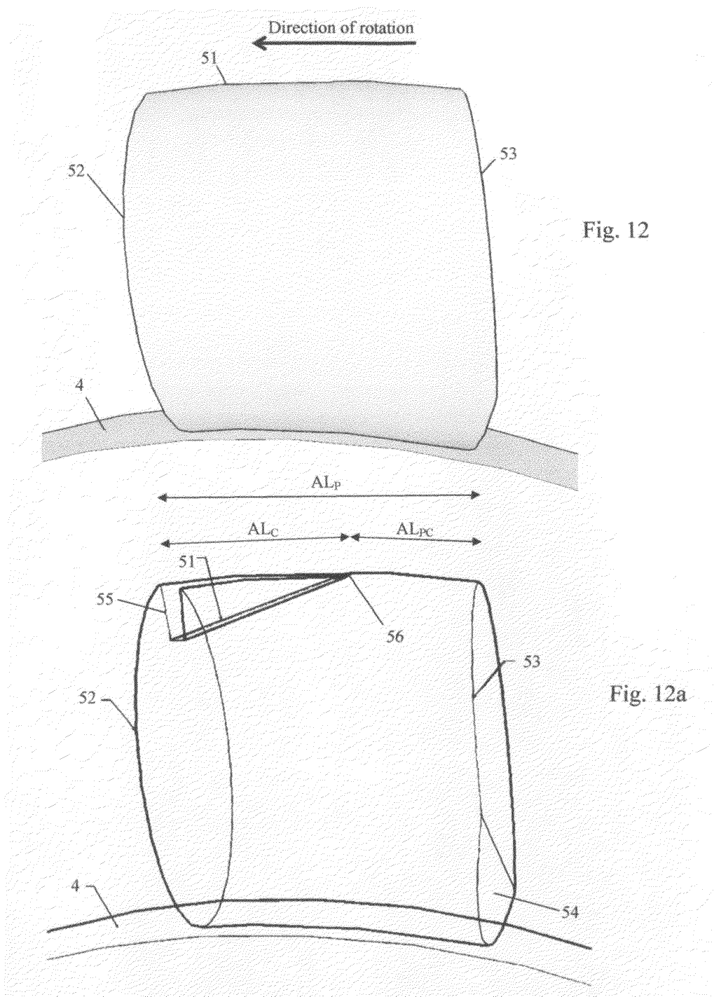

Referring now to FIGS. 12 and 12a, the rear face 53 (or the back surface 53 relative to motion along the circular path, or “Direction of rotation”) of the power-combustion piston(s) may have an angled, partially chamfered or otherwise altered edge 54 (symmetrical or not, flat or not) to allow for a better surface against which the expanding gases of combustion push.

Also, the length of the power-compression piston may be such that the terminus of a machined slot, port, or channel 51 is just beyond the compression chamber's forward edge and the chamfered edge 54 of the piston's rear face still remains just outside the compression chamber's back edge thereby fully containing the compressed air or air/fuel mixture fully in the compression chamber by the lineal side of the piston.

Also, the specific shape and angle of the compression chamber may be such that it provides increased forward momentum for the expanding gases of combustion toward the piston. It is contemplated that pressures of compression within the cylinder could be regulated through the use of a pressure relief device. Further, this engine architecture may be suitable to act as a compressor or pump in addition to more traditional applications. Further, fuel may be added to the gas or air mixture by means of an injection or other fuel induction system located in, or adjacent to, the compression chamber. (This statement is not meant to preclude the use of an aspirated fuel-air mixture in the induction process; however, injection may provide a more efficient means of providing fuel to the combustion process.) This engine, within the constraints of certain parameters, may run on most any hydrocarbon based fuel and is not, as such, limited to a single fuel such as gasoline, diesel, propane, petroleum gas, biofuels, etc., as well as, potentially, hydrogen or other non-carbon-based fuel.

Various further embodiments will now be discussed. Referring again to FIGS. 1, 11, 11a, 12, and 12a, in one embodiment, a non-reciprocating circular engine comprises: a casing 102 comprising a circular path 1; a central hub 2 rotatably connected to the casing 102 and configured to rotate in a preferred direction, which could be clockwise or counterclockwise relative to the drawing shown in FIG. 1; at least one piston 5, 6 connected to the central hub 2 (such as via disc 4) and movable along the circular path 1, the piston 5, 6 having a piston arc length (AL_{P} in FIG. 12a) and a front surface 52 and a back surface 53 relative to motion along the circular path 1; and at least one exhaust gate 10, 12, 14 rotatable about an axis and having an open position and a closed position.

The at least one exhaust gate 10, 12, 14 may be configured to automatically open and close according to a position of the at least one piston 5, 6, such as through the use of sensors, mechanical linkages, actuators, and/or any other device or automatic feedback system known in the art. The at least one exhaust gate 10, 12, 14 rotates from the closed position to the open position in a direction opposite the preferred direction—e.g., if the preferred direction of rotation of the central hub 2 is clockwise, then the exhaust gate 10, 12, 14, rotates in a counterclockwise direction in moving from the closed position to the open position. An advantage of this feature is that in the unlikely event of failure of the exhaust gate 10, 12, 14 to automatically open in time to allow for passage of the at least one piston 5, 6, the piston 5, 6 can push on and subsequently open the exhaust gate 10, 12, 14 without necessarily causing a catastrophic collision or failure of the non-reciprocating circular engine.

The non-reciprocating circular engine further comprises at least one intake gate 11, 13, 15 rotatable about an axis and having an open position and a closed position. The intake gate 11, 13, 15 is similar to the exhaust gate 10, 12, 14 insofar as it is configured to automatically open and close according to a position of the at least one piston 5, 6 and it rotates from the closed position to the open position in a direction opposite the preferred direction.

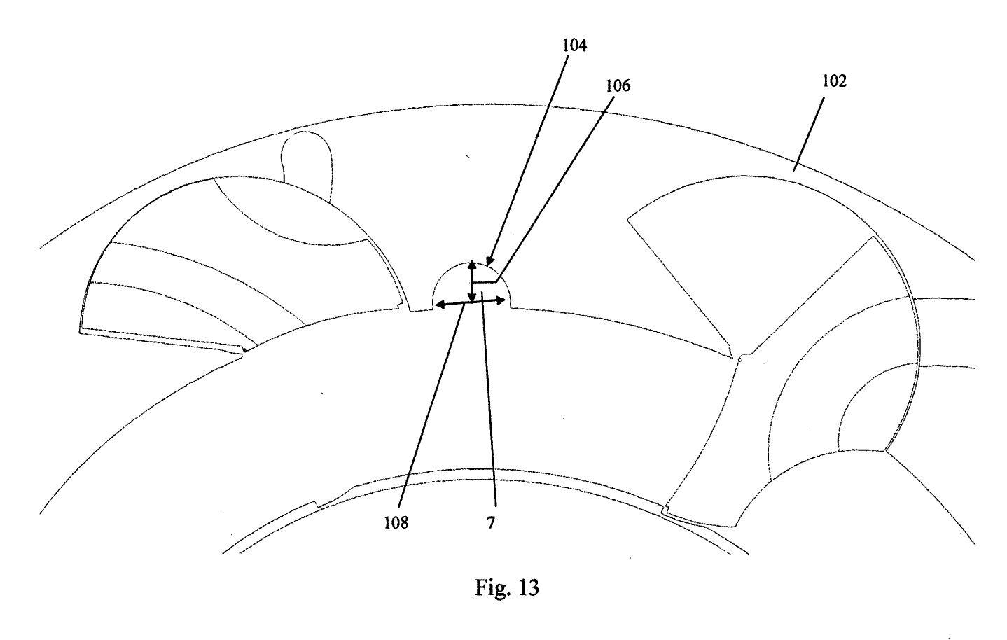

The non-reciprocating circular engine further comprises at least one compression chamber 7, 8, 9 located circumferentially between the at least one exhaust gate and the at least one intake gate along a shortest path—e.g., compression chamber 7 is located circumferentially between exhaust gate 10 and intake gate 11 along a shortest path along circular path 1. Referring briefly to FIG. 13, the compression chamber 7 comprises a recession 104 formed into the casing 102. The central hub 2 is caused to rotate at least in part by force exerted by high pressure combustion gases between the back surface 53 of the at least one piston 5, 6 and the at least one exhaust gate 10, 12, 14 in its closed position.

Further, the at least one piston 5, 6 comprises a channel 51 extending from a first end 55 to a second end 56, the first end located in at least one of the front surface 52 and the back surface 53, the second end 56 located in a periphery corresponding to a location of the at least one compression chamber 7, 8, 9. For example, in FIG. 12a, the second end 56 is shown on an upper surface of the piston 5, 6 because compression chambers 7, 8, 9 are located (in FIG. 1) along an outer circumference of the circular path 1. However, it for example, compression chambers are located at approximately a central point along circular path 1 (e.g., between the inner and outer circumferences of the circular path 1), then the second end 56 of the channel 51 may be correspondingly located on the piston 5, 6.

The channel 51 may extend a channel arc length (AL_{C} in FIG. 12a) of between approximately 20% and 60% of the piston arc length (AL_{P} in FIG. 12a), more preferably between 20% and 50%, more preferably between 30% and 50%, and more preferably between 40% and 50%. The relationship between AL_{C} and AL_{P} may be such that the body of the power-compression piston 6 will contain the compressed gases in the compression chamber 7, 8, 9 until at least such time as the exhaust gate 10, 12, 14 has closed behind the power-compression piston 6. Similarly, the pressure-containing arc length AL_{PC} may or may not close off forward access to the compression chamber 7, 8, 9 prior to the opening of the compression-intake gate 11, 13, 15.

In order to fully maximize compression ratios, the compressed gases may be contained within the compression chamber 7, 8, 9 until such time as the exhaust gate 10, 12, 14 is fully closed.

In one embodiment, referring again to FIGS. 2 and 8, the at least one exhaust gate (e.g., 14 in FIG. 8) comprises an exhaust conduit 23 within the at least one exhaust gate 14 configured for the passage of exhaust gases. The at least one exhaust gate 14 is configured to align the exhaust conduit 23 with an exhaust port 20 in the casing 102 when the at least one exhaust gate 14 is in the closed position. Further, the at least one intake gate (e.g., 11 in FIG. 2) comprises an intake conduit 22 within the at least one intake gate 11 configured for the passage of intake gases. The at least one intake gate 11 is configured to align the intake conduit 22 with an intake port 17 in the casing 102 when the at least one intake gate 11 is in the closed position. An advantage to this feature is that the gates each have more than one purpose. For example, exhaust gate 14 serves: a) to provide a passage for exhaust gases through exhaust conduit 23 (located within the gate 14) and exhaust port 20 when the exhaust gate 14 is in the closed position, causing the exhaust conduit 23 to align with the exhaust port 20; and b) to provide a surface against which high-pressure combustion gases may push and provide pressure against a back surface 53 of a power-combustion piston 6. Further, intake gate 11 serves: a) to provide a passage for intake gases through intake conduit 22 (located within the gate 11) and intake port 17 when the intake gate 11 is in the closed position, causing the intake conduit 22 to align with the intake port 17; and b) to provide a surface against which gas may be compressed between a back surface of the intake gate 11 and a front surface of the intake-exhaust piston 5.

In one embodiment, referring to FIG. 13, the compression chamber comprises a concave recession 104 formed into the casing 102, the concave recession being rounded and having a compression chamber arc length 108 not greater than the piston arc length (AL_{P} in FIG. 12a). Alternatively or in addition, the compression chamber arc length 108 is greater than a compression chamber height 106.

In one embodiment, the back surface 53 of the at least one piston 5, 6 has a back surface shape that substantially matches an exhaust shape of the at least one exhaust gate 10, 12, 14 on a forward side. For instance, as shown in FIG. 1, the exhaust gates 10, 12, 14 may have a rounded or circular shape on a forward side (i.e., a side toward the preferred direction of rotation when the exhaust gate is closed), and the back surface shape of the back surface 53 of each piston 5, 6 may match this shape so that the two elements “fit” together. As an example but not a limitation, if the exhaust gates 10, 12, 14 have a convex shape on their forward sides, then the back surface shape of the pistons 5, 6 may be correspondingly concave, and so forth.

In one embodiment, the at least one piston 5, 6 comprises a pressure-containing arc length (AL_{PC} in FIG. 12a) through which gas passage within the circular path 1 is substantially restricted, and wherein a compression chamber arc length (108 in FIG. 13) exceeds the pressure-containing arc length (AL_{P} in FIG. 12a) so that for a portion of a cycle gas may pass unobstructed from a front of the at least one piston 5, 6 to a back of the at least one piston. The portion of the piston 5, 6 corresponding to the pressure-containing arc length (AL_{PC} in FIG. 12a) fits snugly within the circular path 1 (such as with piston rings or other means of containing pressure), so that gases (related to combustion, before or after combustion) cannot easily or quickly pass by this portion of the piston 5, 6. In sharp contrast, the channel 51 spanning the channel arc length (AL_{S} in FIG. 12a) allows gases to easily move from the front surface 52 of the piston 6 to the compression chambers 7, 8, 9.

Referring again to FIGS. 1, 12, 12a, in one embodiment, a non-reciprocating circular engine comprises: a power-compression piston 6 connected to the central hub 2 and movable along the circular path, the power-compression piston 6 having a front surface 52 and a back surface 53 relative to motion along the circular path 1; an intake-exhaust piston 5 connected to the central hub 2 and movable along the circular path 1, the intake-exhaust piston having a front surface and a back surface relative to motion along the circular path; and a power-exhaust gate 10, 12, 14 rotatable about an axis and having an open position and a closed position.

The power-exhaust gate 10, 12, 14 is configured to automatically open and close according to a position of at least one of the power-compression piston 6 and the intake-exhaust piston 5, and the power-exhaust gate 10, 12, 14 rotates from the closed position to the open position in a direction opposite the preferred direction.

The non-reciprocating circular engine further comprises a compression-intake gate 11, 13, 15 rotatable about an axis and having an open position and a closed position. The compression-intake gate 11, 13, 15 is configured to automatically open and close according to a position of at least one of the power-compression piston 6 and the intake-exhaust piston 5, and rotates from the closed position to the open position in a direction opposite the preferred direction.

The non-reciprocating circular engine further comprises a compression chamber 7, 8, 9 located circumferentially between the power-exhaust gate 10, 12, 14 and the compression-intake gate 11, 13, 15 along a shortest path, the compression chamber 7, 8, 9 comprising a recession (104 in FIG. 13) formed into the casing 102. The central hub 2 is caused to rotate at least in part by force exerted by high pressure combustion gases between the back surface 53 of the power-compression piston 6 and a front surface of the power-exhaust gate 10, 12, 14 in its closed position. Further, the engine is configured so that, in every cycle, only the power-compression piston 6 provides a power stroke and compresses a gas for combustion, and only the intake-exhaust piston 5 provides for intake of gas and exhaust of combustion gases. Essentially, the functions of power and compression are reserved substantially exclusively to the power-compression piston 6, and the functions of intake and exhaust are reserved substantially exclusively to the intake-exhaust piston 5.

An advantage to this feature is large forces occur only on the power-compression piston 6; a large power force occurs on the back surface 53 of the piston 6 in response to high-pressure combustion gases, and a large resistive compression force occurs on the front surface 52 of the power-compression piston 6 as the piston 6 compresses intake gases. Thus, intake-exhaust piston 5 may be built or manufactured differently (e.g., differently shaped, and so forth) than the power-compression piston 6. Further, the power-compression piston 6 is exposed to much higher temperatures on the front and back surfaces than the intake-exhaust piston 5, causing the temperatures of the respective pistons 5, 6 to remain much more constant throughout a cycle. This is beneficial because constant temperature changes (such as those that occur in standard reciprocating internal combustion engines) reduce efficiency.

The various aspects of the embodiments shown in the drawings may be mixed and matched as desired, where possible. Furthermore, the present invention is not limited to only those embodiments shown.

What is claimed is:

1. A non-reciprocating circular engine, comprising:
a casing comprising a circular path;
a central hub rotatably connected to the casing and configured to rotate in a preferred direction;
at least one piston connected to the central hub and movable along the circular path, the piston having a piston arc length and a front surface and a back surface relative to motion along the circular path;
at least one exhaust gate rotatable about an axis and having an open position and a closed position,
wherein the at least one exhaust gate is configured to automatically open and close according to a position of the at least one piston, and
wherein the at least one exhaust gate rotates from the closed position to the open position in a direction opposite the preferred direction;
at least one intake gate rotatable about an axis and having an open position and a closed position,
wherein the at least one intake gate is configured to automatically open and close according to a position of the at least one piston, and
wherein the at least one intake gate rotates from the closed position to the open position in a direction opposite the preferred direction; and
at least one compression chamber located circumferentially between the at least one exhaust gate and the at least one intake gate along a shortest path, the compression chamber comprising a recession formed into the casing,
wherein the central hub is caused to rotate at least in part by force exerted by high pressure combustion gases between the back surface of the at least one piston and the at least one exhaust gate in its closed position, and
wherein the at least one piston comprises a channel extending from a first end to a second end, the first end located in at least one of the front surface and the back surface, the second end located in a periphery corresponding to a location of the at least one compression chamber.

2. The non-reciprocating circular engine as claimed in claim 1, wherein the first end of the channel is located at the front surface.

3. The non-reciprocating circular engine as claimed in claim 1, wherein the first end of the channel is located at the back surface.

4. The non-reciprocating circular engine as claimed in claim 1, wherein the channel extends a channel arc length of between approximately 20% and 50% of the piston arc length.

5. The non-reciprocating circular engine as claimed in claim 1, wherein the engine comprises at least two pistons, at least two exhaust gates, at least two intake gates, and at least one compression chamber.

6. The non-reciprocating circular engine as claimed in claim 1,
wherein the at least one exhaust gate comprises an exhaust conduit within the at least one exhaust gate configured for the passage of exhaust gases,
wherein the at least one exhaust gate is configured to align the exhaust conduit with an exhaust port in the casing when the at least one exhaust gate is in the closed position,
wherein the at least one intake gate comprises an intake conduit within the at least one intake gate configured for the passage of intake gases, and
wherein the at least one intake gate is configured to align the intake conduit with an intake port in the casing when the at least one intake gate is in the closed position.

7. The non-reciprocating circular engine as claimed in claim 1, wherein the at least one compression chamber comprises a concave recession formed into the casing, the concave recession being rounded and having a compression chamber arc length not greater than the piston arc length.

8. The non-reciprocating circular engine as claimed in claim 7, wherein the compression chamber arc length is greater than a compression chamber height.

9. The non-reciprocating circular engine as claimed in claim 1, wherein the back surface of the at least one piston has a back surface shape that substantially matches an exhaust shape of the at least one exhaust gate on a forward side.

10. The non-reciprocating circular engine as claimed in claim 1, wherein the at least one piston comprises a pressure-containing arc length through which gas passage within the circular path is substantially restricted, and wherein a compression chamber arc length exceeds the pressure-containing arc length so that for a portion of a cycle gas may pass unobstructed from a front of the at least one piston to a back of the at least one piston.

11. A non-reciprocating circular engine, comprising:
a casing comprising a circular path having an inner circumference and an outer circumference;
a central hub rotatably connected to the casing and configured to rotate in a preferred direction;
at least one piston connected to the central hub and movable along the circular path, the piston having a piston arc length and a front surface and a back surface relative to motion along the circular path;
at least one exhaust gate rotatable about an axis, having an open position and a closed position, and comprising an exhaust conduit within the at least one exhaust gate configured for the passage of exhaust gases,
wherein the at least one exhaust gate is configured to automatically open and close according to a position of the at least one piston,
wherein the at least one exhaust gate rotates from the closed position to the open position in a direction opposite the preferred direction, and
wherein the at least one exhaust gate is configured to align the exhaust conduit with an exhaust port in the casing when the at least one exhaust gate is in the closed position;
at least one intake gate rotatable about an axis, having an open position and a closed position, and comprising an intake conduit within the at least one intake gate configured for the passage of intake gases,
wherein the at least one intake gate is configured to automatically open and close according to a position of the at least one piston,
wherein the at least one intake gate rotates from the closed position to the open position in a direction opposite the preferred direction, and
wherein the at least one intake gate is configured to align the intake conduit with an intake port in the casing when the at least one intake gate is in the closed position; and
at least one compression chamber located circumferentially between the at least one exhaust gate and the at least one intake gate along a shortest path, the compression chamber comprising a recession formed into the casing,
wherein the central hub is caused to rotate at least in part by force exerted by high pressure combustion gases between the back surface of the at least one piston and the at least one exhaust gate in its closed position.

12. The non-reciprocating circular engine as claimed in claim 11, wherein the engine comprises at least two pistons, at least two exhaust gates, at least two intake gates, and at least one compression chamber.

13. The non-reciprocating circular engine as claimed in claim 11, wherein the at least one compression chamber comprises a concave recession formed into the casing, the concave recession being rounded and having a compression chamber arc length not greater than the piston arc length.

14. The non-reciprocating circular engine as claimed in claim 13, wherein the compression chamber arc length is greater than a compression chamber height.

15. The non-reciprocating circular engine as claimed in claim 11, wherein the back surface of the at least one piston has a back surface shape that substantially matches an exhaust shape of the at least one exhaust gate on a forward side.

16. The non-reciprocating circular engine as claimed in claim 11, wherein the at least one piston comprises a pressure-containing arc length through which gas passage within the circular path is substantially restricted, and wherein a compression chamber arc length exceeds the pressure-containing arc length so that for a portion of a cycle gas may pass unobstructed from a front of the at least one piston to a back of the at least one piston.

17. A non-reciprocating circular engine, comprising:
a casing comprising a circular path;
a central hub rotatably connected to the casing and configured to rotate in a preferred direction;
a power-compression piston connected to the central hub and movable along the circular path, the power-compression piston having a front surface and a back surface relative to motion along the circular path;
an intake-exhaust piston connected to the central hub and movable along the circular path, the intake-exhaust piston having a front surface and a back surface relative to motion along the circular path;
a power-exhaust gate rotatable about an axis and having an open position and a closed position,
wherein the power-exhaust gate is configured to automatically open and close according to a position of at least one of the power-compression piston and the intake-exhaust piston, and
wherein the power-exhaust gate rotates from the closed position to the open position in a direction opposite the preferred direction;
a compression-intake gate rotatable about an axis and having an open position and a closed position,
wherein the compression-intake gate is configured to automatically open and close according to a position of at least one of the power-compression piston and the intake-exhaust piston, and
wherein the compression-intake gate rotates from the closed position to the open position in a direction opposite the preferred direction; and
a compression chamber located circumferentially between the power-exhaust gate and the compression-intake gate along a shortest path, the compression chamber comprising a recession formed into the casing,
wherein the central hub is caused to rotate at least in part by force exerted by high pressure combustion gases between the back surface of the power-compression piston and a front surface of the power-exhaust gate in its closed position, and
wherein the engine is configured so that, in every cycle, only the power-compression piston provides a power stroke and compresses a gas for combustion, and only the intake-exhaust piston provides for intake of gas and exhaust of combustion gases.

18. The non-reciprocating circular engine as claimed in claim 17, wherein the compression chamber comprises a concave recession formed into the casing, the concave recession being rounded and having a compression chamber arc length not greater than a piston arc length of the power-compression piston.

19. The non-reciprocating circular engine as claimed in claim 18, wherein the compression chamber arc length is greater than a compression chamber height.

20. The non-reciprocating circular engine as claimed in claim 18, wherein the power-compression piston comprises a pressure-containing arc length through which gas passage within the circular path is substantially restricted, and wherein a compression chamber arc length exceeds the pressure-containing arc length so that for a portion of a cycle gas may pass unobstructed from a front of the power-compression piston to a back of the power-compression piston.
